(19) United States
(12) Patent Application Publication
(10) Pub. No.: US 2014/0052696 A1
(43) Pub. Date: Feb. 20, 2014

(54) SYSTEMS AND METHODS FOR VISUAL CATEGORIZATION OF MULTIMEDIA DATA

(71) Applicant: Kourosh Soroushian, San Diego, CA (US)

(72) Inventor: Kourosh Soroushian, San Diego, CA (US)

(73) Assignee: UNITED VIDEO PROPERTIES, INC., Santa Clara, CA (US)

(21) Appl. No.: 13/589,641

(22) Filed: Aug. 20, 2012

(51) Int. Cl. G06F 17/30

(52) U.S. Cl. 707/691; 707/736; 707/749; 707/E17.005

(57) ABSTRACT

Systems and methods for presenting a visual representation of the multimedia genres in multimedia content over time are provided. In particular, a user may be presented with a temporal genre chart that depicts the amount of each multimedia genre contained in a selected multimedia content. The temporal genre chart may also depict the variation in the amount of each multimedia genre over the duration of the multimedia content. Such temporal genre charts may provide a more accurate overview of multimedia content to the user than typical single genre tags or limited content previews.

### BACKGROUND

A tremendous amount of multimedia content is available for user consumption. Faced with too many choices, users sometimes have a hard time deciding what multimedia content to consume. Users sometimes pick multimedia content, such as a movie, for consumption based on either a genre tag or description associated with the content. Alternatively, users select content for consumption by viewing limited portions or trailers of the content. However, genre tags, brief descriptions, or trailers may not capture sufficient detail of the content. For example, a single genre tag classifying a movie as an ‘action’ movie may not be representative of the entire movie. Similarly, it is not always possible for a user to select a multimedia content for viewing based solely on viewing limited portions of the content or trailers.

### SUMMARY OF THE INVENTION

In view of the foregoing, systems and methods for presenting a visual representation of temporal genre categorization of multimedia content are provided. In particular, a user may be given the opportunity to peruse a visual representation of a temporal genre categorization of selected multimedia content. Such visual representation may aid the user in selecting multimedia content to view by showing the user the amounts in which genre attributes are present in various time segments of the multimedia content.

In some embodiments, the user may be presented an option by an interactive media guide to view a temporal genre chart in response to receiving a user selection of a multimedia content. Alternatively, the user may be presented a temporal genre chart automatically for any content that a user interacts with in a listings of multimedia content.

The temporal genre chart may display the amount of a multimedia genre present in the multimedia content in an easily understood form. In some embodiments, the temporal genre chart may be a two-dimensional or a three-dimensional visual representation of the amount of some or all multimedia genres contained in a selected multimedia content over time. The temporal genre chart may be generated by the control circuitry of the user equipment device or it may be generated remotely at a headend facility. In some embodiments, the temporal genre chart may be generated at a remote server facility and may be made available as an Internet service accessible by the user equipment device.

In some embodiments, the system architecture for generating the temporal genre chart may include modules for demultiplexing the multimedia content into different multimedia components, preprocessing the different multimedia components, performing contextual analysis on the multimedia components, assigning genre scores and corresponding confidence factors, resolving conflicting genre scores, and generating the temporal genre chart. These modules may reside on the user equipment device or at a remote server.

In some embodiments, the selected multimedia content for which a temporal genre chart is being generated may be separated into different multimedia components such as video, audio, and text. Each multimedia component may be further divided into time segments. The preprocessing module may determine the relevance of each time segment and may discard time segments with the least relevance.

In some embodiments, the contextual analysis module may process each multimedia component of the selected multimedia content separately. For example, video, audio, and text components may be separately processed. The contextual analysis module may identify multimedia characteristics or attributes indicative of a particular genre. For example, a high degree of motion in the video component may be indicative of the presence of the ‘action’ genre. Audio and text components of the multimedia content may be similarly processed. In some embodiments, different multimedia components of the multimedia content may be processed as a group in order to identify multimedia characteristics that may not be readily identifiable if each multimedia component was processed separately.

In some embodiments, the genre score assignment module may receive the multimedia characteristics identified by the contextual analysis module. The genre score analysis module may then determine a score to assign per genre based on the information received from the contextual analysis module. For example, if a high degree of motion was detected in the video component then the genre score analysis module may assign a high score to the ‘action’ genre. A confidence factor may also be associated with each score per genre where the confidence factor may indicate the accuracy of the score per genre. A score per genre may be assigned for each time segment of each multimedia component of the multimedia content.

In some embodiments, scores per genre assigned to the different multimedia components of the multimedia content may be aggregated to determine an overall score per genre for each time segment of the multimedia content. In some instances, conflicts may be detected in the scores per genre assigned to the different multimedia components. In such cases, the conflict resolution module may resolve the conflict and determine a true score per genre.

In some embodiments, a temporal genre chart generation module may generate the temporal genre chart based on the results obtained by the genre score analysis module and the conflict resolution module. The temporal genre chart may be generated in two, three, or higher dimensions based on user preferences.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIGS. 5A and 5B show illustrative display screens presenting the user with an opportunity to view temporal genre categorization of selected multimedia content, in accordance with an embodiment of the invention;

FIGS. 6A and 6B show illustrative visual representations of a temporal genre categorization of selected multimedia content, in accordance with an embodiment of the invention;

FIG. 7 shows an illustrative display screen prompting a user to confirm a detected genre, in accordance with an embodiment of the invention;

FIG. 8 shows an illustrative block diagram of an algorithm used to generate a visual representation of a temporal genre categorization of a selected multimedia content, in accordance with an embodiment of the invention;

FIG. 9 shows an illustrative block diagram of a system used to generate a visual representation of a temporal genre categorization of a selected multimedia content, in accordance with an embodiment of the invention;

FIG. 10 shows an illustrative database including a mapping from multimedia content characteristics to genre categorization, in accordance with an embodiment of the invention;

FIG. 11 shows an illustrative flow diagram for generating a visual representation of a temporal genre categorization of a selected multimedia content, in accordance with an embodiment of the invention;

FIG. 12 shows an illustrative flow diagram for determining a genre categorization of a video component of a multimedia content, in accordance with an embodiment of the invention; and

FIG. 13 shows an illustrative flow diagram for determining a genre categorization of an audio component of a multimedia content, in accordance with an embodiment of the invention.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

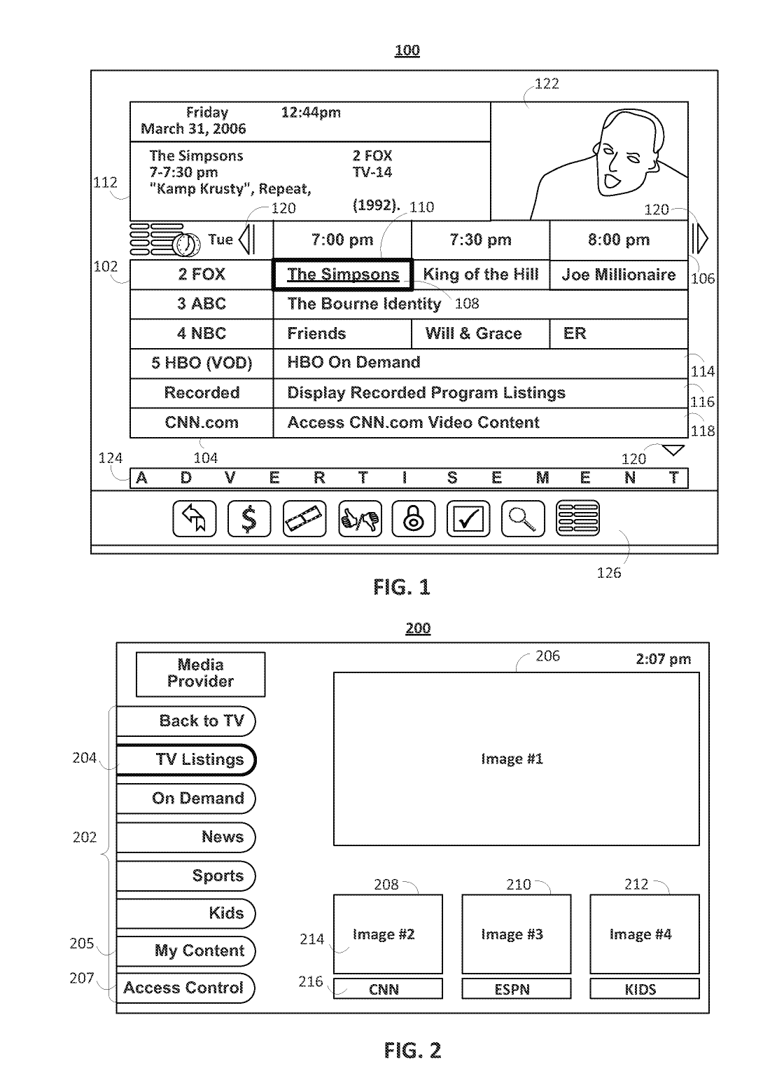

FIGS. 1-2 show illustrative display screens that may be used to provide media guidance data. The display screens shown in FIGS. 1-2, 5, and 7 may be implemented on any suitable user equipment device or platform. While the displays of FIGS. 1-2, 5, and 7 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

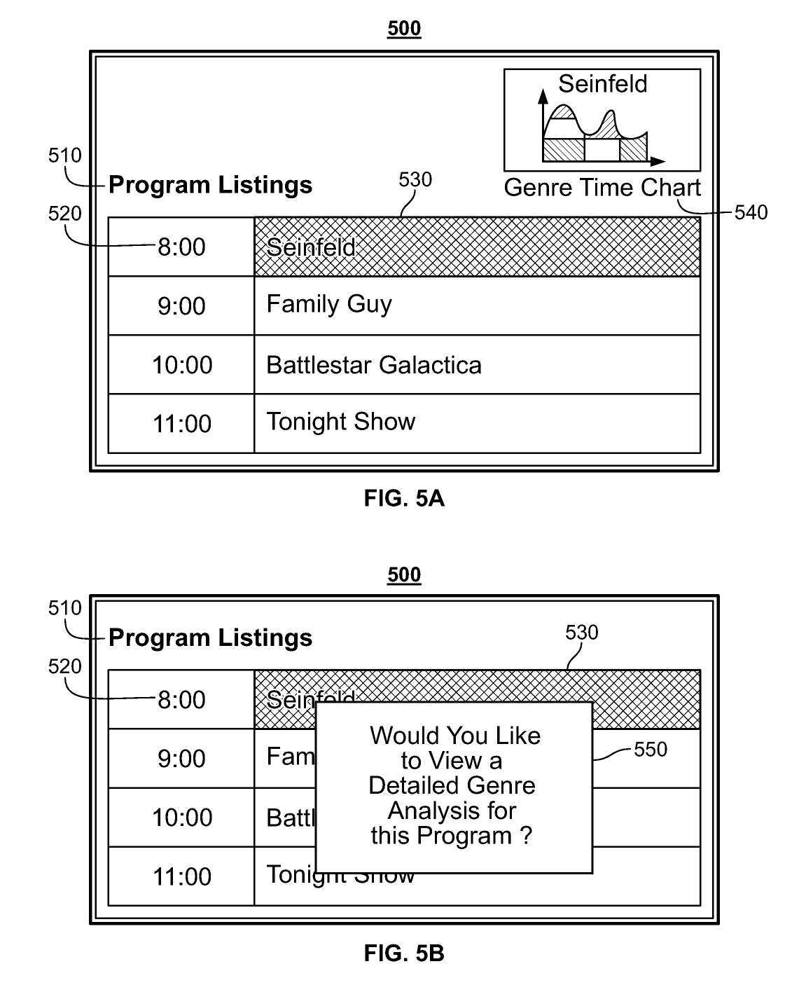

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Users may access content and the media guidance application (and its display screens described above and below) from one or more of their user equipment devices. The user may interact with the listings presented in display 200. In response to the user selection of media content shown in the listings, the media guidance application may present a temporal genre chart to the user. The temporal genre chart may show the amount in which various genre attributes are present in the selected media content over time.

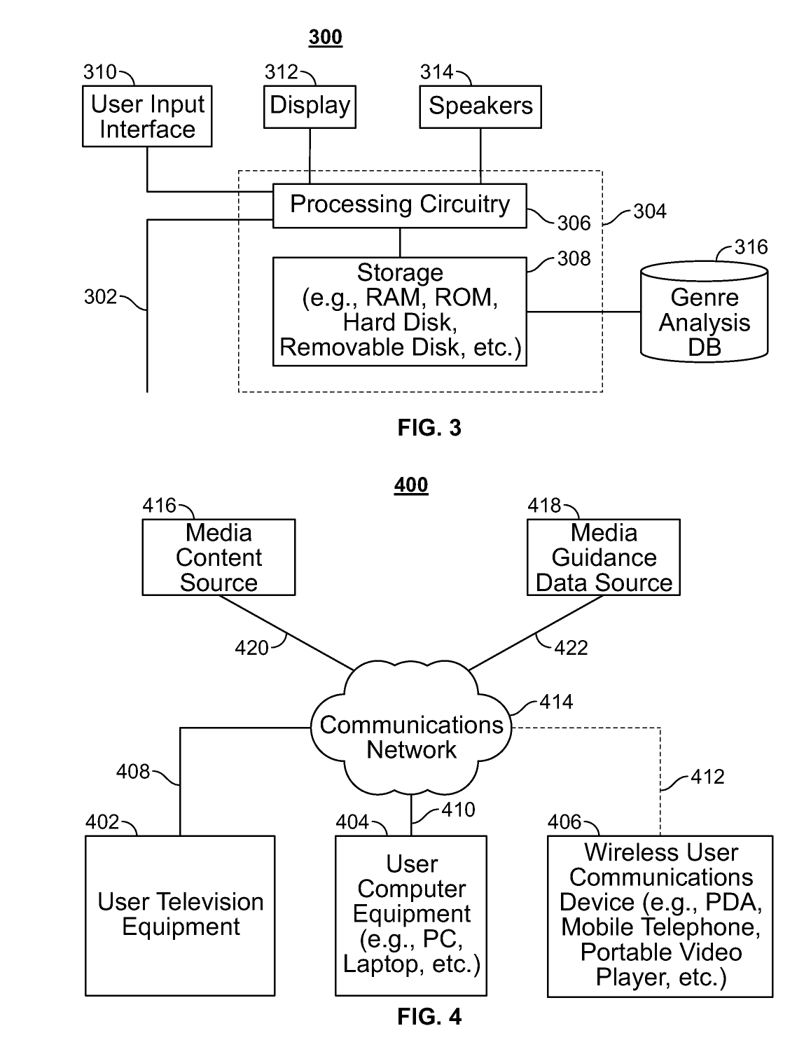

FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A temporal genre chart may be generated by control circuitry 304 of user equipment device 300 or it may be generated remotely at a headend facility. The temporal genre chart may alternatively be generated at a remote server facility and may be made available as an Internet service accessible by user equipment device 300.

In some embodiments, control circuitry 304 may be configured to generate the temporal genre chart and may accordingly include modules for demultiplexing the multimedia content into different multimedia components, preprocessing the different multimedia components, performing contextual analysis on the multimedia components, assigning genre scores and corresponding confidence factors, resolving conflicting genre scores, and generating the temporal genre chart. These modules may reside on user equipment device 300.

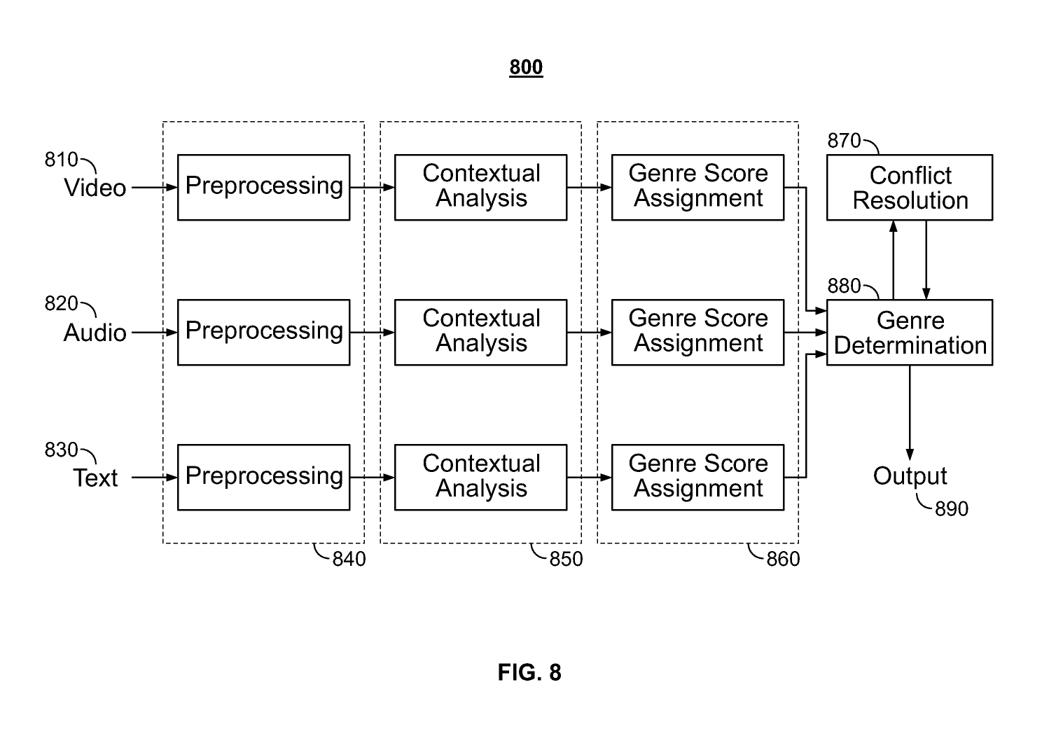

User equipment 300 may include genre analysis database 316. Genre analysis database 316 may be stored in storage 308 or separately. Genre analysis database 316 may contain a mapping from multimedia content characteristics to genre categorization. Genre analysis database 316 may be used by genre score assignment blocks 860 described below in connection with FIG. 8 to assign genre scores.

Genre analysis database 316 may include the fields of multimedia component, characteristic, and genre. Multimedia component field may list multimedia content components such as video, audio, and text. The characteristic field may list media attributes of components such as video, audio, and text. The genre field may list genres such as action, drama, and comedy.

Genre score assignment blocks 860 of FIG. 8 may refer to genre analysis database 316 in order to assign genre scores to time segments of video input, audio input, and text input. For example, if genre score assignment blocks 860 are assigning genre scores to video input, genre score assignment blocks 860 may look up video entries in the multimedia component field of genre analysis database 316. Genre score assignment blocks 860 may cross-reference video element characteristics detected in a time segment of preprocessed video input with the characteristics listed in the characteristic field of genre analysis database 316.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. For example, a temporal genre chart corresponding to a media content selected on the first screen may be presented on the second screen. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing.

In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data source 418 may also be capable of generating temporal genre charts offline and providing relevant data to user equipment device 300 upon user request.

Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment.

The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network.

As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

For illustrative purposes, the present invention is described in the context of an interactive media guide that provides a user access to visual representations of temporal genre categorizations of selected multimedia content. For example, in response to a user selection of a multimedia content presented in listings made available by the interactive media guide, the user may have an opportunity to access a detailed visual representation of temporal categorizations of multimedia attributes of the selected multimedia content.

Multimedia attributes may be any one or a combination of multimedia genres, categories, user profile matches, live or recorded media, popularity metrics, parental guidance aids, language learning aids, or any other suitable multimedia attribute. The following disclosure describes an embodiment where the multimedia attributes are multimedia genres. However, the disclosure is applicable to any of the above multimedia attributes.

A visual representation of temporal genre categorization of selected multimedia content may be a temporal genre chart. Such a chart may be generated by determining, for each time segment of the multimedia content, an amount of each multimedia attribute (e.g., genre). Genres such as comedy, drama, action, romance, tragedy, horror, sci-fi, and thriller, may be used to characterize the multimedia content. Each time segment of the multimedia content may contain a certain amount of a multimedia attribute (e.g., genre). For example, a particular time segment may include elements of comedy and action. Accordingly, the temporal time chart may quantify the precise amounts of comedy and action elements contained in that time segment.

In some embodiments, the temporal genre chart may be a two-dimensional or a three-dimensional visual representation of the amount of some or all multimedia genres contained in a selected multimedia content over time. The temporal genre chart may be generated by the control circuitry of the user equipment device or it may be generated remotely at a headend facility. In some embodiments, the temporal genre chart may be generated at a remote server facility and may be made available as an Internet service accessible by the user equipment device.

In some embodiments, the system architecture for generating the temporal genre chart may include modules for demultiplexing the multimedia content into different multimedia components, preprocessing the different multimedia components, performing contextual analysis on the multimedia components, assigning genre scores and corresponding confidence factors, resolving conflicting genre scores, and generating the temporal genre chart. These modules may reside on the user equipment device or at a remote server.

In some embodiments, the selected multimedia content for which a temporal genre chart is being generated may be separated into different multimedia components such as video, audio, and text. Each multimedia component may be further divided into time segments. The preprocessing module may determine the relevance of each time segment and may discard time segments with the least relevance.

In some embodiments, the contextual analysis module may process each multimedia component of the selected multimedia content separately. For example, video, audio, and text components may be separately processed. The contextual analysis module may identify multimedia characteristics or attributes indicative of a particular genre. For example, a high degree of motion in the video component may be indicative of the presence of the ‘action’ genre. Audio and text components of the multimedia content may be similarly processed. In some embodiments, different multimedia components of the multimedia content may be processed as a group in order to identify multimedia characteristics that may not be readily identifiable if each multimedia component was processed separately.

In some embodiments, the genre score assignment module may receive the multimedia characteristics identified by the contextual analysis module. The genre score analysis module may then determine a score to assign per genre based on the information received from the contextual analysis module. For example, if a high degree of motion was detected in the video component then the genre score analysis module may assign a high score to the ‘action’ genre. A confidence factor may also be associated with each score per genre where the confidence factor may indicate the accuracy of the score per genre. A score per genre may be assigned for each time segment of each multimedia component of the multimedia content.

In some embodiments, scores per genre assigned to the different multimedia components of the multimedia content may be aggregated to determine an overall score per genre for each time segment of the multimedia content. In some instances, conflicts may be detected in the scores per genre assigned to the different multimedia components. In such cases, the conflict resolution module may resolve the conflict and determine a true score per genre.

In some embodiments, a temporal genre chart generation module may generate the temporal genre chart based on the results obtained by the genre score analysis module and the conflict resolution module. The temporal genre chart may be generated in two, three, or higher dimensions based on user preferences.

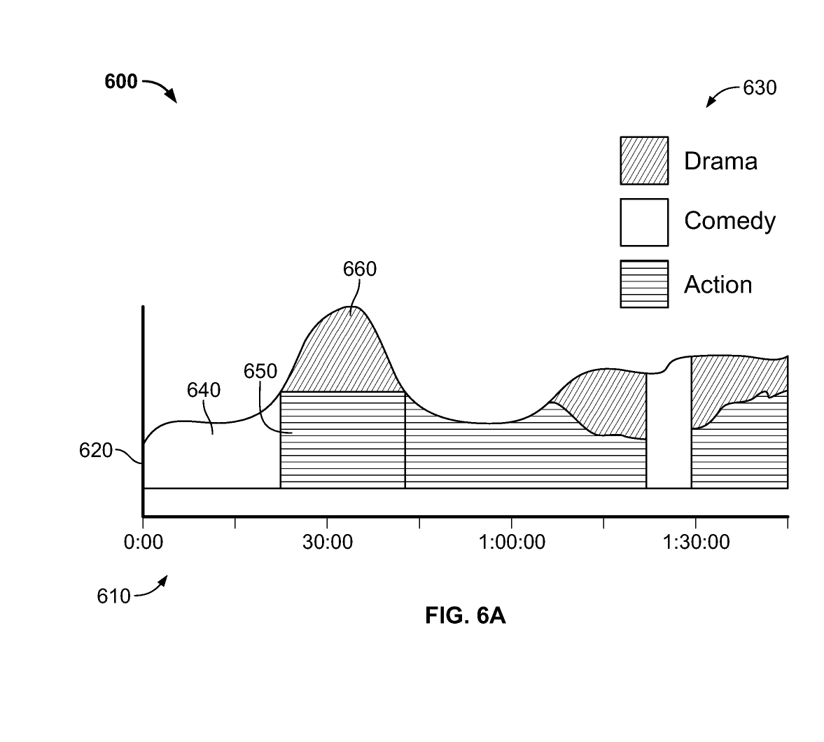

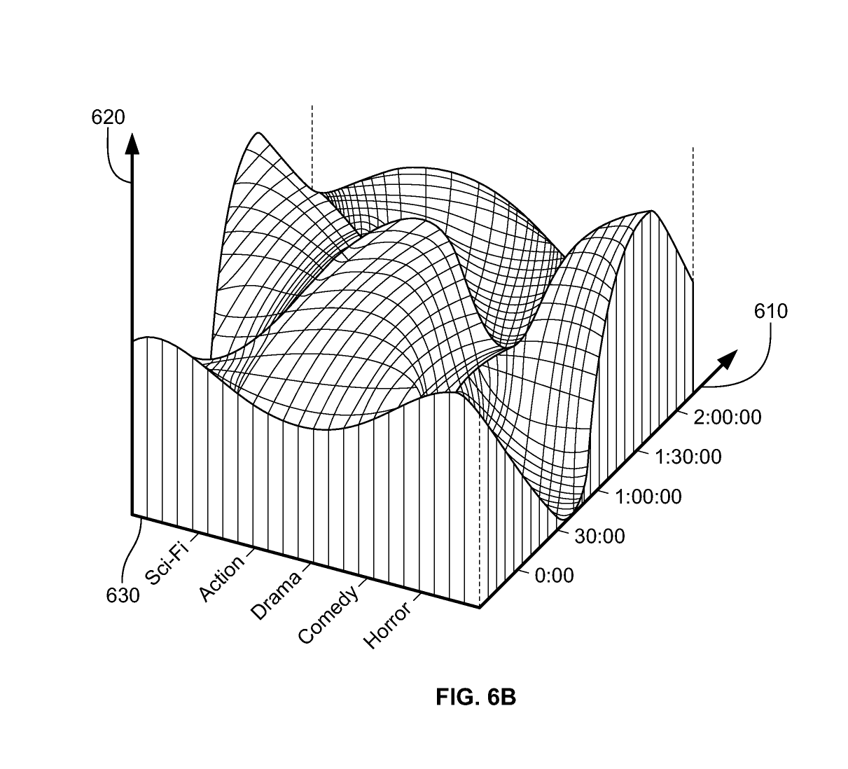

FIGS. 5A and 5B show illustrative display screens presenting the user with an opportunity to view temporal genre categorization of selected multimedia content, in accordance with an embodiment of the invention. FIG. 5A shows a display screen presenting a visual representation of temporal genre categorization of selected media content to the user. Screen 500 shows multimedia content listings including title bar 510 and multimedia content listings 520. Multimedia content listings 520 may include a time region, indicating the times during which a multimedia content is available to the user, and a title region, indicating the titles of the multimedia content. Screen 500 may also include temporal genre chart 540 which is discussed in greater detail below in connection with FIGS. 6A and 6B.

In an embodiment, the user may be perusing multimedia content listings 520 provided by the interactive media guide and may select a multimedia content listed. For example, the user may place a cursor over multimedia content titled “Seinfeld” and press a button to highlight/select the content. For example, multimedia content listings 520 of FIG. 5A include highlight region 530 showing that the user has selected ‘Seinfeld’. The user may alternatively use any other suitable method for selecting multimedia content of interest.

Once the user has selected a multimedia content of interest, the interactive media guide may automatically display temporal genre chart 540 corresponding to the selected multimedia content. Temporal genre chart 540 may be displayed in any appropriate location on screen 500. For example, temporal genre chart 540 may be displayed in a corner of screen 500 where clips of the selected content may previously have been displayed. For example, temporal genre chart 540 may be displayed at the location of a cursor being controlled by the user.

In some embodiments, temporal genre chart 540 may be displayed in an overlay on top of a display of the multimedia content selected by the user. For example, the selected multimedia content may be presented to the user by the interactive media guide on display 312 and temporal genre chart 540 may be overlaid on top of the display of the selected multimedia content. The overlay may be semi-transparent or non-transparent. Temporal genre chart 540 may show the genre scores beginning at the current playback position of the multimedia content and for a limited time into the future. For example, the first time segment displayed on temporal genre chart 540 may correspond to the time segment containing the current playback position of the selected multimedia content. The final time segment displayed on temporal genre chart 540 may correspond to the time segment containing the end of the selected multimedia content.

FIG. 5B shows a display screen presenting the user with an option to view a visual representation of temporal genre categorization of selected media content. Screen 500 of FIG. 5B shows multimedia content listings including title bar 510 and multimedia content listings 520. Title bar 510 and multimedia content listings 520 may be substantially similar to title bar 510 and multimedia content listings 520 of FIG. 5A.

Screen 500 of FIG. 5B may additionally include prompt 550 which may request user input regarding whether the user wishes to view temporal genre chart 540. Prompt 550 may be presented on screen 500 by the interactive media guide when a user selection of a media content presented in media content listings 530 is received by processing circuitry 306 via user input interface 310. For example, when a user highlights/selects ‘Seinfeld’ on media content listings 530, the interactive media guide may display prompt 540.

Prompt 540 may request the user to input whether the user would like to view temporal genre chart 540 corresponding to the selected multimedia content. For example, if the user indicates that the user would like to view temporal genre chart 540, the interactive media guide may display temporal genre chart 540 on screen 500. Temporal genre chart 540 may be displayed on screen 500 as described above in connection with FIG. 5A. If the user indicates no interest in viewing temporal genre chart 540, via user input interface 310 or by providing no response for a predetermined period of time, the interactive media guide may remove prompt 540 and not display temporal genre chart 540.

FIGS. 6A and 6B show illustrative visual representations of a temporal multimedia attribute categorization of selected multimedia content, in accordance with an embodiment of the invention. FIG. 6A shows a two dimensional (2D) visual representation of temporal multimedia attribute chart 600. Temporal multimedia attribute chart 600 may be substantially similar to temporal multimedia attribute chart 540 discussed above in connection with FIG. 5A. Temporal multimedia attribute chart 600 includes time scale 610, magnitude scale 620, and legend 630. Legend 630 may show a legend of all the multimedia attributes indicated in temporal multimedia attribute chart 600.

Time scale 610 may indicate time segments of the selected multimedia content. In an embodiment, time scale 610 includes indicators representing various time segments of the multimedia content to which temporal multimedia attribute chart 600 corresponds.

For example, time scale 610 may include indicators marking 30 minute time segments of the multimedia content. The indicators accordingly run from time 0:00 till the end of the multimedia content in 15:00 minute intervals. Suitable indicators marking time at other intervals may also be used. The time intervals may be customizable by the user or may be based on user preferences.

Magnitude scale 620 may indicate the amount of each multimedia attribute present in each time segment of the multimedia content to which temporal multimedia attribute chart 600 corresponds. Each time segment indicated on temporal multimedia attribute chart 600 may include a representation of the amount of a multimedia attribute present in that time segment. For example, if the multimedia attributes are categories, the first 15:00 minute time segment of temporal multimedia attribute chart 600 may be characterized solely as education because it may contain only educational elements. For example, if the multimedia content to which temporal multimedia attribute chart 600 corresponds is a movie, the first 15 minutes of the movie may contain a math puzzle.

Accordingly, the first 15:00 minute time segment of temporal multimedia attribute chart 600 may be represented exclusively by the educational tag 640.

The amount of multimedia attribute in a time segment may be variable, as indicated by the variation in magnitude of multimedia attribute 640 of temporal multimedia attribute chart 600 in the first 15:00 minute time segment. If a time segment contains only one multimedia attribute, the area under the curve of temporal multimedia attribute chart 600 may be indicative of the score of the multimedia attribute.

In some embodiments, the amount of a multimedia attribute in a time segment of the selected media content may be determined by the system described below in greater detail in connection with FIG. 8. For example, the system may analyze the dialog spoken across frames in a time segment. The system may covert the dialog to text and look for consistent use of educational terminology. Identified educational terms may be used to determine the amount of educational content in the time segment. For example, educational content may vary over the time segment. The ebb and flow of educational terms across the time segment may correspond to peaks and troughs of temporal multimedia attribute chart 600 corresponding to educational multimedia attribute 640.

The second 15:00 minute time segment of temporal multimedia attribute chart 600 may be characterized by both adult and violence because the multimedia content may contain both adult and violent elements during that time segment. For example, if the multimedia content to which temporal multimedia attribute chart 600 corresponds is a movie, the second 15:00 minutes of the movie may contain a car chase scene with tense dialog. Accordingly, the second 15:00 minute time segment of temporal multimedia attribute chart 600 may be represented by adult multimedia attribute 660 and violent multimedia attribute 650, as shown in FIG. 6A. Similarly, the remaining time segments of the multimedia content may be represented by appropriate multimedia attributes.

The height of violent multimedia attribute 650 in the second 15:00 minute time segment may be indicative of the score assigned to violent multimedia attribute 650. As shown in FIG. 6A, the score assigned to a multimedia attribute may be constant over a time segment—indicating that the amount of that multimedia attribute in that time segment remains constant. The difference between the height of adult multimedia attribute 660 and the height of violent multimedia attribute 660 may be indicative of the score assigned to adult multimedia attribute 660. For example, as shown in FIG. 6A, the amount of adult multimedia attribute 660 may vary over the second 15:00 minute time segment—specifically, the amount of adult multimedia attribute 660 may be the largest in the middle of the second 15:00 minute time segment.

In some embodiments, the multimedia attributes represented in temporal multimedia attribute chart 600 may be interactive. For example, the user may click on or select any of the multimedia attributes shown in FIG. 6A. In response to receiving an indication via user input interface 310 that the user wishes to interact with any one or combination of the multimedia attributes shown in temporal multimedia attribute chart 600, the interactive media guide may perform any one or combination of the following actions. For example, if the user selects violent multimedia attribute 650, the user may be shown a preview of the second 15:00 minute time segment of the selected multimedia content, the user may be given an option to playback the selected content from the time segment that contains the selected multimedia attribute, the user may be presented with a list of media content that also contain violent multimedia attribute 650, the user may be presented with a list of media attributes due to which the second 15:00 minute time segment of the selected multimedia content was categorized as violent, the user may be given an option to view only those time segments of the selected multimedia segment that contain violence, the user may be given an option to view only those time segments of the selected multimedia segment that do not contain violence, or the user may be presented with an option to modify the multimedia attribute categorization.

The options described above may be presented to the user by the interactive media guidance application on a display screen similar to screen 500. Some or all of the options described above may be presented to the user on the display screen. The user may then select one of the presented options. For example, if the user selects the option to playback the selected content from the time segment that contains the selected multimedia attribute, playback of the multimedia content from the appropriate time position may begin.

In some embodiments, temporal multimedia attribute chart 600 may visually represent how well certain portions of the selected multimedia content match the interests of the user as indicated by the user profile. For example, the height of portions of temporal multimedia attribute chart 600 on magnitude scale 620 may correspond to the degree to which the selected multimedia content matches the user's interests. For example, if the user profile indicates that the user is interested in horses, then all portions of the selected multimedia content which contain any reference to horses may be marked with high magnitude values in temporal multimedia attribute chart 600. The magnitude values of portions of temporal multimedia attribute chart 600 may be proportional to the percent match between a genre of the multimedia content and the user profile.

FIG. 6B shows a three dimensional (3D) visual representation of temporal multimedia attribute chart 600. Temporal multimedia attribute chart 600 includes time scale 610, magnitude scale 620, and multimedia attribute scale 630. Time scale 610 and magnitude scale 620 of FIG. 6B may be substantially similar to time scale 610 and magnitude scale 620 of FIG. 6A. In some implementations, time scale 610 and magnitude scale 620 may constitute the z and x axes, respectively, of temporal multimedia attribute chart 600. Any other suitable arrangement may also be used. Genre scale 630 may indicate some or all of the possible genres. In an example, multimedia attribute scale 630 may be arranged along the y axis of temporal multimedia attribute chart 600. In some implementations, multimedia attribute scale 630 may include only those multimedia attributes that are present in the selected media content. In some implementations, multimedia attribute scale 630 may include all possible multimedia attributes.

Multimedia attributes depicted in the 3D visual representation of temporal multimedia attribute chart 600 in FIG. 6B may be interactive as described above in connection with FIG. 6A. Temporal multimedia attribute chart 600 of FIG. 6B may itself be interactive. For example, the user may drag, rotate, pinch, zoom-in, zoom-out, or click temporal multimedia attribute chart 600. In response to clicking a multimedia attribute shown on temporal multimedia attribute chart 600, the user may be presented with options as described above in connection with FIG. 6A. In some embodiments, the user may select any of the multimedia attributes shown on multimedia attribute scale 630. In response to the user selection, the interactive media guide may update temporal multimedia attribute chart 600 such that only the portions of temporal multimedia attribute chart 600 corresponding to the multimedia attribute selected by the user are visible. In some embodiments, the user may select any of the time segments show on time scale 610. In response to the user selection, the interactive media guide may update temporal multimedia attribute chart 600 such that only the portions of temporal multimedia attribute chart 600 corresponding to the time segment selected by the user are visible. The 3D visual representation of temporal multimedia attribute chart 600 in FIG. 6B is merely illustrative and any other suitable 3D or multi-dimensional visual representation may also be used.

In an embodiment, FIGS. 6A and 6B show illustrative visual representations of a temporal genre categorization of selected multimedia content, in accordance with an embodiment of the invention. FIG. 6A shows a two dimensional (2D) visual representation of temporal genre chart 600. Temporal genre chart 600 may be substantially similar to temporal genre chart 540 discussed above in connection with FIG. 5A. Temporal genre chart 600 includes time scale 610, magnitude scale 620, and legend 630. Legend 630 may show a legend of all the genres indicated in temporal genre chart 600. For example, if temporal genre chart 600 includes the genres action, comedy, and drama, legend 630 may include these genres.

Time scale 610 may indicate time segments of the selected multimedia content. In an embodiment, time scale 610 includes indicators representing various time segments of the multimedia content to which temporal genre chart 600 corresponds. For example, time scale 610 may include indicators marking 30 minute time segments of the multimedia content. The indicators accordingly run from time 0:00 till the end of the multimedia content in 15:00 minute intervals. Suitable indicators marking time at other intervals may also be used. The time intervals may be customizable by the user or may be based on user preferences.

Magnitude scale 620 may indicate the amount of each genre present in each time segment of the multimedia content to which temporal genre chart 600 corresponds. Each time segment indicated on temporal genre chart 600 may include a representation of the amount of a genre present in that time segment. For example, the first 15:00 minute time segment of temporal genre chart 600 may be characterized solely as a comedy because it may contain only humorous elements. For example, if the multimedia content to which temporal genre chart 600 corresponds is a movie, the first 15 minutes of the movie may be filled with jokes and pranks. Accordingly, the first 15:00 minute time segment of temporal genre chart 600 may be represented exclusively by the comedy genre 640, as shown in FIG. 6A.

The amount of comedy in a time segment may be variable, as indicated by the variation in magnitude of comedy genre 640 of temporal genre chart 600 in the first 15:00 minute time segment. For example, people may laugh more towards the end of the first 15:00 minute segment rather than the beginning. Accordingly, the score assigned to the comedy genre, as shown by magnitude scale 620, may be greater towards the end of the first 15:00 minute time segment. Specifically, if a time segment contains only one genre, the area under the curve of temporal genre chart 600 may be indicative of the score of the genre.

In some embodiments, the amount of a genre in a time segment of the selected media content may be determined by the system described below in greater detail in connection with FIG. 8. For example, the system may analyze the facial expressions of actors in a scene using any suitable facial recognition technology to identify and track faces of actors across frames. The system may further identify expressions of the tracked faces. Identified facial expressions may be used to determine the emotions being portrayed by the actors in scenes. For example, actors may laugh in varying degrees across the frames. Accordingly, the system may associate laughter with comedy genre 640.

The ebb and flow of laughter across the frame may correspond to peaks and troughs of temporal genre chart 600 corresponding to comedy genre 640.

The second 15:00 minute time segment of temporal genre chart 600 may be characterized by both drama and action because the multimedia content may contain both drama and action elements during that time segment. For example, if the multimedia content to which temporal genre chart 600 corresponds is a movie, the second 15:00 minutes of the movie may contain a car chase scene with tense dialog. Accordingly, the second 15:00 minute time segment of temporal genre chart 600 may be represented by drama genre 660 and action genre 650, as shown in FIG. 6A. Similarly, the remaining time segments of the multimedia content may be represented by appropriate genres.

The height of action genre 650 in the second 15:00 minute time segment may be indicative of the score assigned to action genre 650. As shown in FIG. 6A, the score assigned to a genre may be constant over a time segment—indicating that the amount of that genre in that time segment remains constant. The difference between the height of drama genre 660 and the height of action genre 660 may be indicative of the score assigned to drama genre 660. For example, as shown in FIG. 6A, the amount of drama genre 660 may vary over the second 15:00 minute time segment—specifically, the amount of drama genre 660 may be the largest in the middle of the second 15:00 minute time segment.

In some embodiments, the genres represented in temporal genre chart 600 may be interactive. For example, the user may click on or select any of the genres shown in FIG. 6A. In response to receiving an indication via user input interface 310 that the user wishes to interact with any one or combination of the genres shows in temporal genre chart 600, the interactive media guide may perform any one or combination of the following actions. For example, if the user selects action genre 650, the user may be shown a preview of the second 15:00 minute time segment of the selected multimedia content, the user may be given an option to playback the selected content from the time segment that contains the selected genre, the user may be presented with a list of media content that also contain action genre 650, the user may be presented with a list of media attributes due to which the second 15:00 minute time segment of the selected multimedia content was categorized as action, the user may be given an option to view only those time segments of the selected multimedia segment that contain action, the user may be given an option to view only those time segments of the selected multimedia segment that do not contain action, or the user may be presented with an option to modify the genre categorization.

The options described above may be presented to the user by the interactive media guidance application on a display screen similar to screen 500. Some or all of the options described above may be presented to the user on the display screen. The user may then select one of the presented options. For example, if the user selects the option to playback the selected content from the time segment that contains the selected genre, playback of the multimedia content from the appropriate time position may begin.

In some embodiments, temporal genre chart 600 may visually represent how well certain portions of the selected multimedia content match the interests of the user as indicated by the user profile. For example, the height of portions of temporal genre chart 600 on magnitude scale 620 may correspond to the degree to which the selected multimedia content matches the user's interests. For example, if the user profile indicates that the user is interested in horses, then all portions of the selected multimedia content which contain any reference to horses may be marked with high magnitude values in temporal genre chart 600. The magnitude values of portions of temporal genre chart 600 may be proportional to the percent match between a genre of the multimedia content and the user profile.

FIG. 6B shows a three dimensional (3D) visual representation of temporal genre chart 600. Temporal genre chart 600 includes time scale 610, magnitude scale 620, and genre scale 630. Time scale 610 and magnitude scale 620 of FIG. 6B may be substantially similar to time scale 610 and magnitude scale 620 of FIG. 6A. In some implementations, time scale 610 and magnitude scale 620 may constitute the z and x axes, respectively, of temporal genre chart 600. Any other suitable arrangement may also be used. Genre scale 630 may indicate some or all of the possible genres. In an example, genre scale 630 may be arranged along the y axis of temporal genre chart 600. For example, genre scale 630 may include genres such as sci-fi, action, drama, comedy, horror, or any other suitable genre. In some implementations, genre scale 630 may include only those genres that are present in the selected media content. In some implementations, genre scale 630 may include all possible genres.

Genres depicted in the 3D visual representation of temporal genre chart 600 in FIG. 6B may be interactive as described above in connection with FIG. 6A. Temporal genre chart 600 of FIG. 6B may itself be interactive. For example, the user may drag, rotate, pinch, zoom-in, zoom-out, or click temporal genre chart 600. In response to clicking a genre shown on temporal genre chart 600, the user may be presented with options as described above in connection with FIG. 6A. In some embodiments, the user may select any of the genres shown on genre scale 630. In response to the user selection, the interactive media guide may update temporal genre chart 600 such that only the portions of temporal genre chart 600 corresponding to the genre selected by the user are visible. In some embodiments, the user may select any of the time segments show on time scale 610. In response to the user selection, the interactive media guide may update temporal genre chart 600 such that only the portions of temporal genre chart 600 corresponding to the time segment selected by the user are visible. The 3D visual representation of temporal genre chart 600 in FIG. 6B is merely illustrative and any other suitable 3D or multi-dimensional visual representation may also be used.

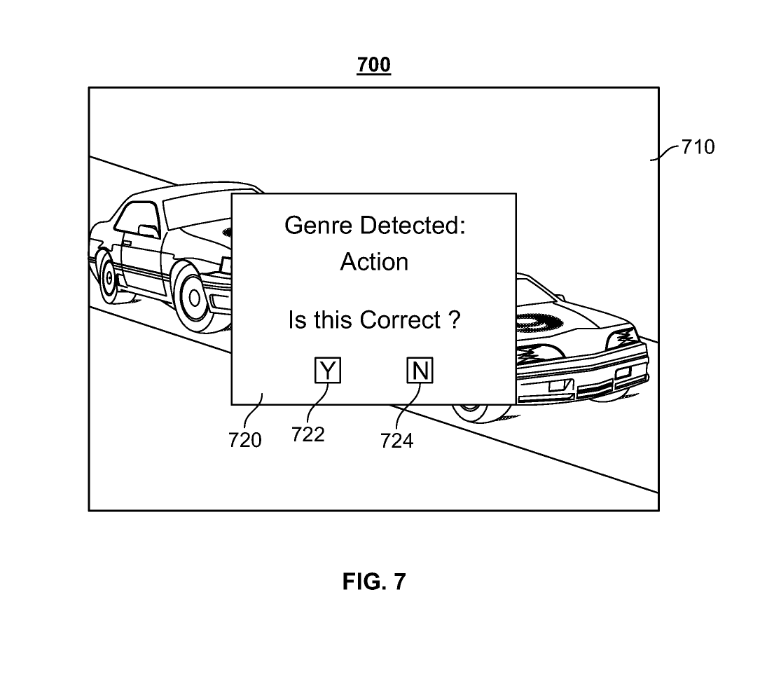

FIG. 7 shows an illustrative display screen prompting a user to confirm a detected genre, in accordance with an embodiment of the invention. Screen 700 includes display 710, prompt 720, confirm box 722, and decline box 724. Display 710 may be a scene of a multimedia content currently being viewed by a user. Alternatively and/or additionally, display 710 may correspond to a scene of a multimedia content for which the user has requested access to a temporal genre chart or display 710 may correspond to a scene of a multimedia content for which user input is required to resolve a conflict with regards to the genre categorization of the scene.

Prompt 720 may include a brief message indicating to the user the genre categorization that has been detected. Prompt 720 may additionally request the user to confirm the detected genre categorization.

The user may confirm the detected genre using confirm box 722. Confirm box 722 may be a text, graphic, or any other suitable indicator that the user may press, select, highlight, or interact with in any other suitable manner. The user may veto the detected genre using decline box 724. Decline box 724 may be substantially similar to confirm box 722.

Prompt 720 may be displayed to the user by the interactive media guide in situations where a final determination as to the genre categorization of a time segment of a multimedia content cannot accurately be made, as described below in greater detail in connection with FIG. 8. For example, as shown in display 710, a scene in a multimedia content may contain a car chase. The genre—action—may be detected but without high accuracy. Accordingly, user input may be helpful in confirming the genre categorization of the multimedia scene. Prompt 720 may therefore be displayed on screen 700.

FIG. 8 shows an illustrative block diagram of an algorithm used to generate a visual representation of a temporal genre categorization of a selected multimedia content, in accordance with an embodiment of the invention. System 800 receives video input 810, audio input 820 and text input 830. System 800 includes preprocessing blocks 840, contextual analysis blocks 850, genre score assignment blocks 860, score combination block 880, and conflict resolution block 870. System 800 generates output 890.

Video input 810, audio input 820, and text input 830 may be multimedia components of the multimedia content whose temporal genre chart is being generated via system 800. In an implementation, control circuitry 304 may demultiplex the multimedia content into video, audio, and text components. The video component may correspond to the video portion of the multimedia content. The audio component may correspond to the soundtrack and dialog portion of the multimedia content. The text component may correspond to the subtitles and/or closed-captioning portion of the multimedia content. Video input 810, audio input 820, and text input 830 may be processed by system 800 in parallel via preprocessing blocks 840, contextual analysis blocks 850, and genre score assignment blocks 860.

In some implementations, system 800 may include three preprocessing blocks 840, three contextual analysis blocks 850, and three genre score assignment blocks 860 in order to process video input 810, audio input 820, and text input 830 concurrently.

Each of video input 810, audio input 820, and text input 830 may be processed in turn by one of the preprocessing blocks 840, contextual analysis blocks 850, and genre score assignment blocks 860.

Preprocessing blocks 840 may eliminate certain types of elements from video input 810, audio input 820, and/or text input 830. Preprocessing blocks 840 may divide each of video input 810, audio input 820, and text input 830 signals into multiple time segments. For example, video input 810 may be divided into non-overlapping consecutive time segments of duration 15:00 minutes. Time segments of any other suitable duration may also be used. In some implementations, the time segments may overlap with each other. Audio input 820 and text input 830 may be divided into corresponding time segments aligned with the time segments of video input 810. In some implementations, video input 810, audio input 820, and text input 830 may already be divided into time segments before being received by preprocessing blocks 840.

A first preprocessing block of preprocessing blocks 840 may preprocess video input 810. The preprocessing block may operate on discrete time segments of video input 810. For example, video scenes that are too bright or too dark may be eliminated from video input 810 because they may provide insufficient information to make any determination of the genre categorization of those scenes. More generally, video scenes that provide insufficient information to make any determination of the genre categorization may be eliminated. The preprocessing block may additionally clean up video input 810 to minimize distortion.

A second preprocessing block of preprocessing blocks 840 may separate audio input 820 into a dialog component and background music component. The preprocessing block may eliminate portions of audio input 820 in which both the dialog component and background music component are silent because they provide insufficient information to make any determination of the genre categorization of those portions of audio input 820. The preprocessing block may convert the dialog component to a text component in some implementations. The preprocessing block may additionally clean up audio input 820 to minimize distortion.

A third preprocessing block of preprocessing blocks 840 may preprocess text input 830. The preprocessing block may eliminate portions of text input 830 in which there is no text because they provide insufficient information to make any determination of the genre categorization of those portions of text input 830. The preprocessing block may additionally clean up text input 830 to minimize noise and improve readability of text input 830.

After video input 810, audio input 820, and text input 830 have been preprocessed by preprocessing blocks 840, the preprocessed video input 810, audio input 820, and text input 830 signals may be received by contextual analysis blocks 850. Contextual analysis blocks 850 may analyze the preprocessed video input 810, audio input 820, and text input 830 signals to identify visual, audio, or text elements indicative of genre.

A first contextual analysis block of contextual analysis blocks 850 may analyze preprocessed video input 810. The contextual analysis block may examine a number of visual elements of the preprocessed video input 810. For example, the contextual analysis block may consider the degree of motion of various objects from one frame to the next in a time segment, the number of scene changes or frame cuts in a given time segment, and/or the facial expressions of actors in a scene. Other suitable visual elements may also be analyzed. Visual elements may also be analyzed across multiple time segments.

In evaluating the degree of motion from one frame to the next, the contextual analysis block may recognize objects in a frame and track the movement of the recognized objects across multiple frames in a time segment. Objects in a frame may be recognized using any suitable visual recognition technology, such as technology relying on machine learning. Tracked objects may be evaluated to determine whether they move rapidly or slowly across frames. Such an evaluation may lead to a determination of the amount of movement in frames and may be used to gauge the amount of action in a time segment.

In evaluating the number of scene changes or frame cuts, the contextual analysis block may identify all the scene changes and/or frame cuts in a time segment. For example, the contextual analysis block may look for abrupt changes in scenes or a break in continuity of scenes. The contextual analysis block may track the number of identified scene changes or frame cuts. Such a count may be used to gauge the amount of action in a time segment.

In evaluating the facial expressions of actors in a scene, the contextual analysis block may use any suitable facial recognition technology to identify and track faces of actors across frames. The contextual analysis block may further identify expressions of the tracked faces. Identified facial expressions may be used to determine the emotions being portrayed by the actors in scenes. Such a determination may be used to gauge the amount of action, terror, comedy, drama, thrill, or any other suitable genre.

A second contextual analysis block of contextual analysis blocks 850 may analyze preprocessed audio input 820. The contextual analysis block may examine a number of audio elements of the preprocessed audio input 820. For example, the contextual analysis block may analyze the background music of a time segment and/or the dialog of a time segment. Other suitable audio elements may also be analyzed. Audio elements may also be analyzed across multiple time segments.

In evaluating the background music in a time segment, the contextual analysis block may detect the instruments used, the beats present, and/or fingerprint the music. For example, the detection of instruments like the cello or violin at a slow tempo may indicate an emotional scene. The detection of thumping bass may indicate a dramatic or action scene. The contextual analysis block may compare the detected instruments and/or beats to a genre detection database to determine a corresponding genre.

In evaluating the dialog in a time segment, the contextual analysis block may consider the dialog as well as the text version of the dialog. The contextual analysis block may receive the text corresponding to the dialog from the preprocessing block. The contextual analysis block may identify the amount of dialog and/or the type of dialog. For example, excessive dialog may indicate a comedy or a drama. Dialog with yelling may indicate a drama, action, or thriller, dialog with laughing may indicate a comedy, and dialog with crying may indicate a thriller or a drama. Similarly, other attributes of the dialog may indicate other suitable genres. In some implementations, the text version of the dialog may be examined in a manner similar to the evaluation of preprocessed text input 830, as described below.

A third contextual analysis block of contextual analysis blocks 850 may analyze preprocessed text input 830. The contextual analysis block may examine a number of text elements, such as elements of subtitles, of the preprocessed text input 830. For example, the contextual analysis block may analyze the number of expletives used in a time segment and/or perform natural language analysis. Other suitable text elements may also be analyzed. Text elements may also be analyzed across multiple time segments.

In evaluating the number of expletives used in a time segment, the contextual analysis block may count the number of occurrences of expletives in the text element in a time segment. A high count may indicate drama, action, or thriller. Similarly, the contextual analysis block may count the number of occurrences of words indicative of emotion, laughter, or any other suitable attribute.

In performing natural language analysis of text in a time segment, the contextual analysis block may evaluate the occurrence of certain words in the text relative to the occurrence of other words. For example, if the word “boy” occurs together with the word “oh,” the phrase may indicate drama. If the word “boy” occurs with the phrase “watch out!” it may indicate action. The above examples are merely illustrative and any other suitable context based analysis may also be applied.

The results of the analysis performed by contextual blocks 850 may be transmitted to genre score assignment blocks 860. Genre score assignment blocks 860 may assign a score per genre for each time segment of video input 810, audio input 820, and text input 830. A first genre score assignment block of genre score assignment blocks 860 may assign a score per genre for each time segment of video input 810 based on contextual analysis results received from contextual analysis blocks 850. For example, if contextual analysis blocks 850 made a determination that the frames in a time segment contain a high degree of movement, then the genre score assignment block may assign a high score to action for that time segment. If contextual analysis blocks 850 made a determination a time segment contains a high number of frame cuts and/or scene changes, then the genre score assignment block may assign a high score to action for that time segment. If contextual analysis blocks 850 made a determination that the facial expressions in a time segment indicate a high degree of terror, then the genre score assignment block may assign a high score to horror for that time segment. Any other suitable genre scoring strategy may also be used.

A second genre score assignment block of genre score assignment blocks 860 may assign a score per genre for each time segment of audio input 820 based on contextual analysis results received from contextual analysis blocks 850. For example, if contextual analysis blocks 850 detected instruments like the cello or violin playing at a slow tempo in a time segment, indicating an emotional scene, then the genre score assignment block may assign a high score to drama for that time segment. If contextual analysis blocks 850 detected thumping bass in a time segment, indicating an action or drama scene, then the genre score assignment block may assign a high score to drama or action for that time segment. If contextual analysis blocks 850 detected dialog with a lot of yelling in a time segment, indicating an emotional scene, then the genre score assignment block may assign a high score to drama for that time segment. Any other suitable genre scoring strategy may also be used.

A third genre score assignment block of genre score assignment blocks 860 may assign a score per genre for each time segment of text input 830 based on contextual analysis results received from contextual analysis blocks 850. For example, if contextual analysis blocks 850 detected text with a lot of expletives in a time segment, then the genre score assignment block may assign a high score to drama, action, and/or thriller for that time segment. Any other suitable genre scoring strategy may also be used.

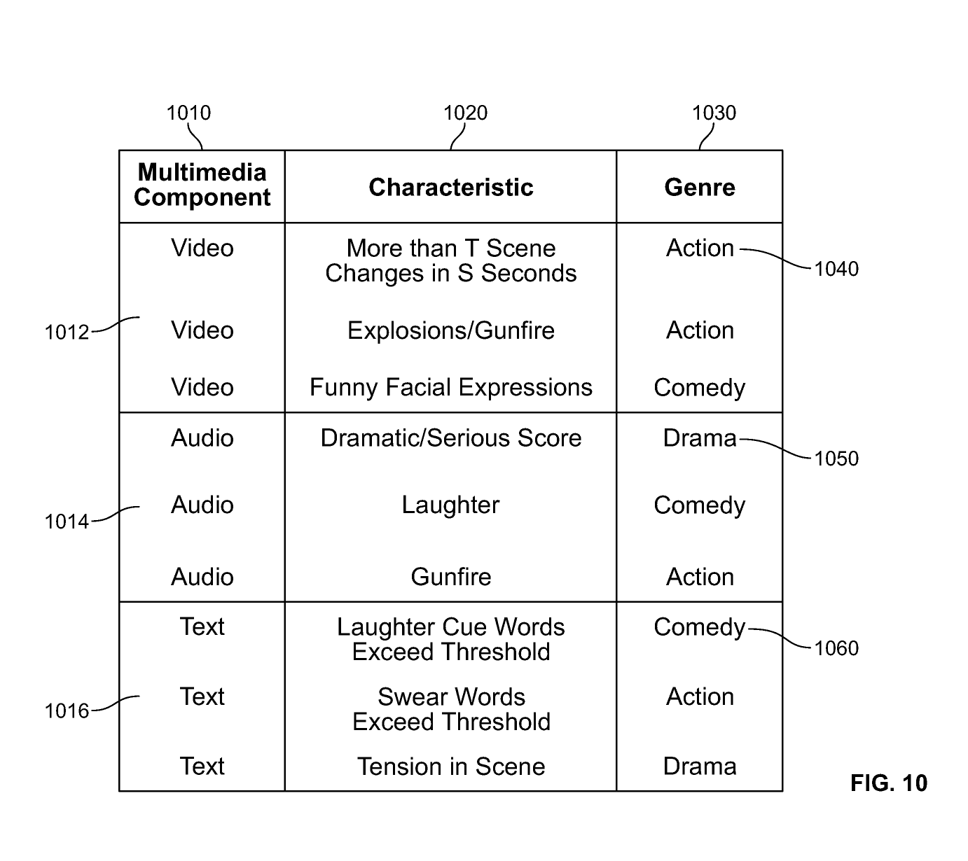

In some implementations, genre score assignment blocks 860 may refer to genre analysis database 316 when assigning scores to each genre in a time segment, as discussed in greater detail below in connection with FIG. 10.

A high score assigned to a genre in a time segment may indicate the presence of a greater amount of that genre in the time segment. A low score assigned to a genre in a time segment may indicate the presence of a lower amount of that genre in the time segment. For example, genre score assignment blocks 860 may assign scores to genres on a scale of 0-100 or any other suitable scale. In some implementations, the scores may be normalized. In some implementations, the scores may be assigned in terms of percentages. In some implementations, the score assigned to genres may also vary within each time segment.

Genre score assignment blocks 860 may assign confidence factors to each score that they assign. Confidence factors may indicate the reliability or accuracy of the assigned score. A high value of a confidence factor may indicate a greater reliability of the assigned score. Confidence factors may be assigned based on the perceived reliability of the analysis performed by contextual analysis blocks 850. For example, if the number of detected frame cuts or scene changes in a time segment exceeds a threshold by a large number then the action genre may be assigned a high score with a high confidence factor. On the other hand, if the number of detected frame cuts or scene changes in a time segment is close to the threshold then the action genre may be assigned a medium score with a low confidence factor. Other suitable techniques for assigning confidence factors may also be employed.

Genre score assignment blocks 860 may apply a filtering process in order to smooth out the variations in the scores assigned to genres across consecutive time segments of video input 810, audio input 820, and text input 830. The filtering process may be applied to video input 810, audio input 820, and text input 830 individually. For example, the scores assigned to horror in time segments of video input 810 may be smoothed out by application of the filtering process. Any suitable filtering process may be used. For example, smoothing processes such as low pass filtering, Kalman filtering, or recursive filtering may be used.

In some implementations, preprocessing blocks 840, contextual analysis blocks 850, and genre score assignment blocks 860 may not operate on discrete time segments of video input 810, audio input 820, and text input 830. Instead, preprocessing blocks 840, contextual analysis blocks 850, and genre score assignment blocks 860 may operate on continuous portions of video input 810, audio input 820, and text input 830. In this case, genre score assignment blocks 860 may determine the duration of the occurrence of each genre. For example, genre score assignment blocks 860 may assign genre scores to continuous portions of video input 810, audio input 820, and text input 830.

Genre score assignment blocks 860 may transmit the assigned genre scores, confidence factors, and any other relevant information to genre determination block 880 which may generate a score per genre for each time segment of the multimedia content. Genre determination block 880 may combine the separate genre scores received for video input 810, audio input 820, and text input 830 into aggregate genre scores for the multimedia content. The aggregate genre scores may take into account the confidence factors assigned to the genre scores. For example, an aggregate score for the action genre may be generated for a time segment of the multimedia content using a weighted sum of the scores assigned to the action genre in that time segment of video input 810, audio input 820, and text input 830, where the confidence factors assigned to each genre score may be used as the weights in the weighted sum. This process may be repeated for each time segment of the multimedia content in order to generate an aggregate score for each time segment. Any other suitable aggregation technique may also be employed for generating the aggregate genre score.

In a given time segment of a multimedia content, there may be variation in the scores assigned to a genre in that time segment of video input 810, audio input 820, and text input 830. For example, the score assigned to the horror genre in a time segment of video input 810 may be high, while the score assigned to the horror genre in the same time segment of audio input 820 may be low. Genre determination block 880 may attempt to resolve such discrepancies or conflicts. Genre determination block 880 may rely on conflict resolution block 870 to do this.

Conflict resolution block 870 may receive the assigned genre scores, confidence factors, and any other relevant information to genre determination block 880. In some implementations, conflict resolution block 870 may resolve the conflict by relying on user input. For example, the user may be prompted to determine whether the user is available to resolve a conflict. If the user is available, the time segment of the multimedia content containing the conflict may be displayed to the user. An overlay may display the genre scores assigned to each genre and the user may be prompted to select the genre the user would like to assign to the time segment displayed. Based on the user's selection of a genre, conflict resolution block 870 may assign a high score to the genre picked by the user for the time segment displayed for video input 81, audio input 820, as well as text input 830. A high value for a confidence factor may also be assigned. Conflict resolution block 870 may further utilize the user input to learn and improve the genre analysis and score algorithms employed by contextual analysis blocks 850 and genre score assignment blocks 860.

In some implementations, conflict resolution block 870 may resolve the conflict without relying on user input. For example, conflict resolution block 870 may rely on a predetermined formula. The predetermined formula may receive as inputs the scores assigned to the conflicting genres. The predetermined formula may have access to a database of genre scores assigned to time segments similar to the time segments in which the current genre conflict has been detected. The predetermined formula may rely on the database of genre scores to resolve the current conflict by using any suitable machine learning algorithms.

System 800 may generate output 890 based on the genre scores determined by genre determination block 880. Output 890 may be data that may be used to generate temporal genre chart 600. In some implementations, output 890 may be temporal genre chart 600.

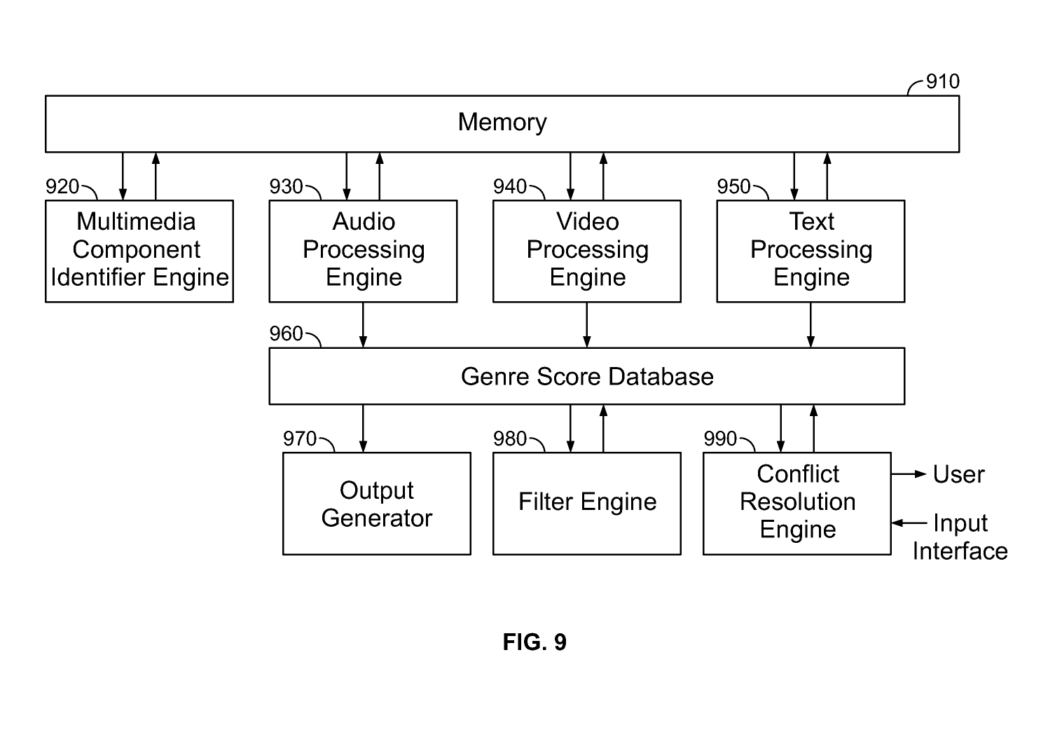

FIG. 9 shows an illustrative block diagram of a system used to generate a visual representation of a temporal genre categorization of a selected multimedia content, in accordance with an embodiment of the invention. System 900 includes memory 910, multimedia component identifier engine 920, audio processing engine 930, video processing engine 940, text processing engine 950, genre score database 960, output generator 970, filter engine 980, and conflict resolution engine 990. Some or all of these components may be part of control circuitry 304.

Memory 910 may be coupled via communication lines to multimedia component identifier engine 920, audio processing engine 930, video processing engine 940, and text processing engine 950. Memory 910 may be substantially similar to storage 308. Memory 910 may be internal or external. In some implementations, the multimedia content for which a temporal genre chart is being generated may be stored in memory 910.

Multimedia component identifier engine 920 may demultiplex the multimedia content into video, audio, and text components and thus generate video input 810, audio input 820, and text input 830 of FIG. 8. For example, multimedia component identifier engine 920 may extract the video portion of the multimedia content to generate video input 810, extract the audio portion to generate audio input 820, and extract the subtitles to generate text input 830.

Multimedia component identifier engine 920 may store the extracted video input 810, audio input 820, and text input 830 back in memory 910.

Video processing engine 940 may perform the preprocessing, contextual analysis, and genre score assignment for video input 810 as discussed above in connection with FIG. 8. Video processing engine 940 may read video input 810 from memory 910 to perform the preprocessing, contextual analysis, and genre score assignment. Video processing engine 940 may store intermediate results of the preprocessing, contextual analysis, and genre score assignment in memory 910.

Audio processing engine 930 may perform the preprocessing, contextual analysis, and genre score assignment for audio input 820 as discussed above in connection with FIG. 8. Audio processing engine 930 may read video input 810 from memory 910 to perform the preprocessing, contextual analysis, and genre score assignment. Audio processing engine 930 may store intermediate results of the preprocessing, contextual analysis, and genre score assignment in memory 910.

Text processing engine 950 may perform the preprocessing, contextual analysis, and genre score assignment for text input 830 as discussed above in connection with FIG. 8. Text processing engine 950 may read video input 810 from memory 910 to perform the preprocessing, contextual analysis, and genre score assignment. Text processing engine 950 may store intermediate results of the preprocessing, contextual analysis, and genre score assignment in memory 910.

Genre score database 960 may be stored in storage 308. Genre score database 960 may be stored using any suitable technology. Genre score database 960 may be a SQl or any other suitable relational or other database. Genre score database 960 may be coupled via communication lines to audio processing engine 930, video processing engine 940, text processing engine 950, output generator 970, filter engine 980, and conflict resolution engine 990. Genre score database 960 may be substantially similar to genre analysis database 316. Audio processing engine 930, video processing engine 940, and text processing engine 950 may store the results of the genre score assignment process in genre score database 960.

Filter engine 980 may smooth out the variations in the scores assigned to genres across consecutive time segments of video input 810, audio input 820, and text input 830. Audio processing engine 930, video processing engine 940, and text processing engine 950 may send instructions to filter engine 980 via communication lines (not shown) to request the filtering. Filter engine 980 may be coupled via communication lines to genre score database 960. Filter engine 980 may read, from genre database 960, genre scores across consecutive time segments of video input 810, audio input 820, and text input 830. Filter engine 980 may perform the smoothing operation on the read data and write the results back to genre score database 960.

Conflict resolution engine 990 may be coupled via communication lines to genre score database 960.

Conflict resolution engine 990 may perform conflict resolution as described above in connection with FIG. 8. Control circuitry 304 may instruct conflict resolution engine 990 to perform conflict resolution after filter engine 980 has finished smoothing out variations in the assigned genre scores. Conflict resolution engine 990 may read the genre scores, confidence factors, and any other relevant information from genre score database 960, resolve any conflicts and write the results back to genre score database 960. Conflict resolution engine 990 may be coupled to user input interface 310.

Output generator 970 may be coupled via communication lines to genre score database 960 and may generate temporal genre chart 600 based on the genre scores stored in genre score database 960. Control circuitry 304 may instruct output generator 970 to generate the output once conflict resolution engine 990 has completed resolving any conflicts.

FIG. 10 shows an illustrative database including a mapping from multimedia content characteristics to genre categorization, in accordance with an embodiment of the invention. Database 1000 may be substantially similar to genre analysis database 316. Database 1000 may be used by genre score assignment blocks 860 described above in connection with FIG. 8 to assign genre scores. Database 1000 may be stored in storage 308.

Database 1000 may include the fields of multimedia component 1010, characteristic 1020, and genre 1030. Multimedia component field 1010 may list multimedia content components such as video 1012, audio 1014, and text 1016. Characteristic field 1020 may list media attributes of components such as video 1012, audio 1014, and text 1016. Genre field 1030 may list genres such as action 1040, drama 1050, and comedy 1060.

Genre score assignment blocks 860 of FIG. 8 may refer to database 1000 in order to assign genre scores to time segments of video input 810, audio input 820, and text input 830. For example, if genre score assignment blocks 860 are assigning genre scores to video input 810, genre score assignment blocks 860 may look up video 1012 entries in multimedia component field 1010. Genre score assignment blocks 860 may cross-reference video element characteristics detected in a time segment of preprocessed video input 810 with the characteristics listed in characteristic field 1020. If a match is found, genre score assignment blocks 860 may then read off the genre from the row corresponding to the matching characteristic to determine the genre associated with that characteristic. If an exact match is found, genre score assignment blocks 860 may associate a high genre score to the genre associated with the matching characteristic.

For example, if contextual analysis blocks 850 detect more than ‘T’ frame cuts or scene changes in a time segment of duration ‘S’ seconds, where ‘T’ is a threshold and ‘S’ is the duration of time segments, then according to database 1000, the time segment contains action. Accordingly, genre score assignment blocks 860 may assign a high score to action for this time segment. Genre score assignment blocks 860 may also associate a high confidence factor to the score assigned to the action genre if the number of detected frame cuts or scene changes far exceeds threshold ‘T.’ The examples illustrated in database 1000 are merely illustrative and other suitable combinations of multimedia components, characteristics, and genres may also be used.

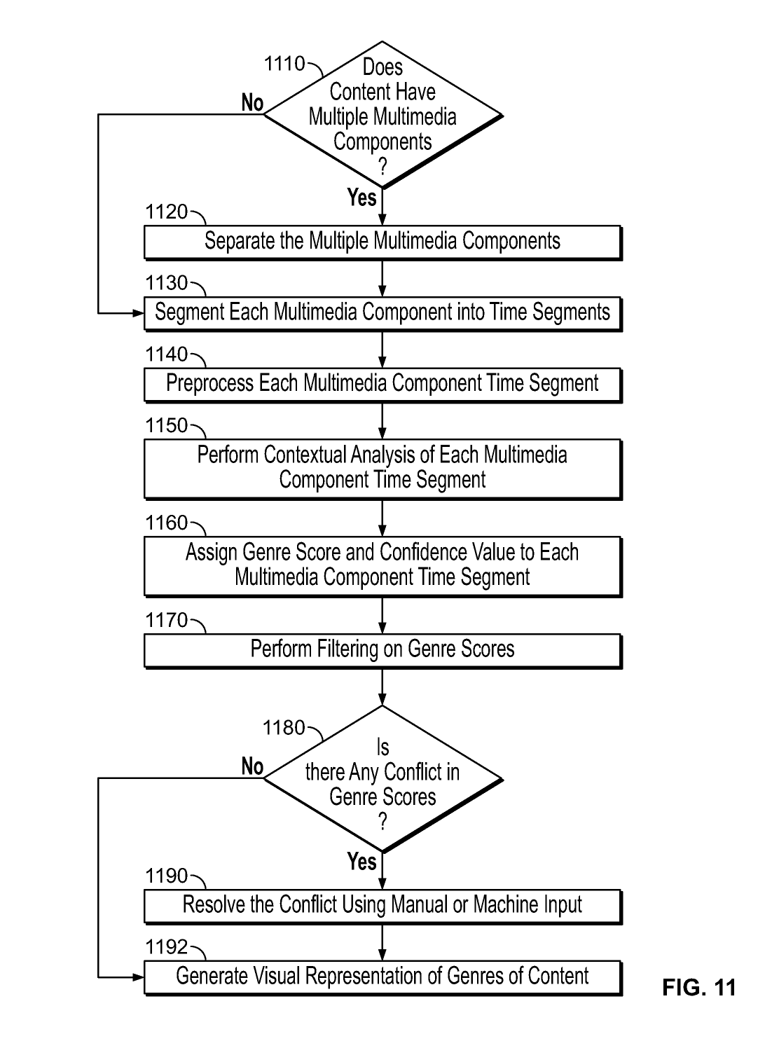

FIG. 11 shows an illustrative flow diagram for generating a visual representation of a temporal genre categorization of a selected multimedia content, in accordance with an embodiment of the invention. At step 1110, a determination may be made as to whether the multimedia content for which a temporal genre chart is being generated contains multiple multimedia components such as video, audio, and text. For example, movies include all three multimedia components while music includes only an audio component. In response to a determination that the multimedia content includes multiple multimedia components, the process proceeds to step 1120 where multimedia component identifier engine 920 demultiplexes the multimedia content into separate multimedia components to generate some or all of video input 810, audio input 820, and text input 830. Otherwise the process proceeds to step 1130.

At step 1130, each demultiplexed multimedia component of the multimedia content may be divided into multiple time segments. For example, time segments may be of equal lengths or variable lengths. Dividing components into time segments may allow multimedia content to be processed faster because different time segments may be processed by control circuitry 304 in parallel. Accordingly, control circuitry 304 may be able to generate a temporal genre chart more quickly.

At step 1140, time segments of components may be preprocessed. If the multimedia content contained all three components, then video input 810, audio input 820, and text input 830 may be preprocessed by audio processing engine 930, video processing engine 940, and text processing engine 950. Otherwise, if the multimedia content contained only, say, an audio component, then audio input 940 may be preprocessed by audio processing engine 930. Time segments may be preprocessed either sequentially or in parallel. All or some of the time segments may be preprocessed. Preprocessing may occur in the manner described above in connection with FIGS. 8 and 9.

At step 1150, preprocessed time segments may undergo contextual analysis processing. Contextual analysis may be performed in the manner described above in connection with FIGS. 8 and 9. For example, audio processing engine 930, video processing engine 940, and text processing engine 950 may respectively perform contextual analysis on video input 810, audio input 820, and text input 830.

At step 1160, a score per genre and a corresponding confidence factor may be assigned to each time segment of each multimedia component. Genre score and confidence factor assignment may occur in the manner described above in connection with FIGS. 8 and 9. The assigned genre scores and confidence factors may be stored in genre score database 960.

At step 1170, the genre scores assigned across time segments in each multimedia component may be filtered for smoothing. Filtering may occur in the manner described above in connection with FIGS. 8 and 9. At step 1180, a determination may be made as to whether there is any conflict in the assigned genre scores. Conflicting genre scores may be possible if the multimedia content has more than one multimedia component. For example, conflicting genre scores may not be possible if the multimedia content is a music file. In response to a determination that there is a conflict in genre scores, the process may proceed to step 1190. Otherwise the process may proceed to step 1192.

At step 1190, conflicting genre scores may be resolved. Conflict resolution may occur in the manner described above in connection with FIGS. 8 and 9. For example, conflict resolution engine 990 may request user input in order to resolve the conflict and decide the score of a genre of a time segment of a multimedia component. The process may end at step 1192 temporal genre chart 600 corresponding to the multimedia content may be generated. For example, output generator 970 may generate temporal genre chart 600 based on the outcome of steps 1110-1190 above.

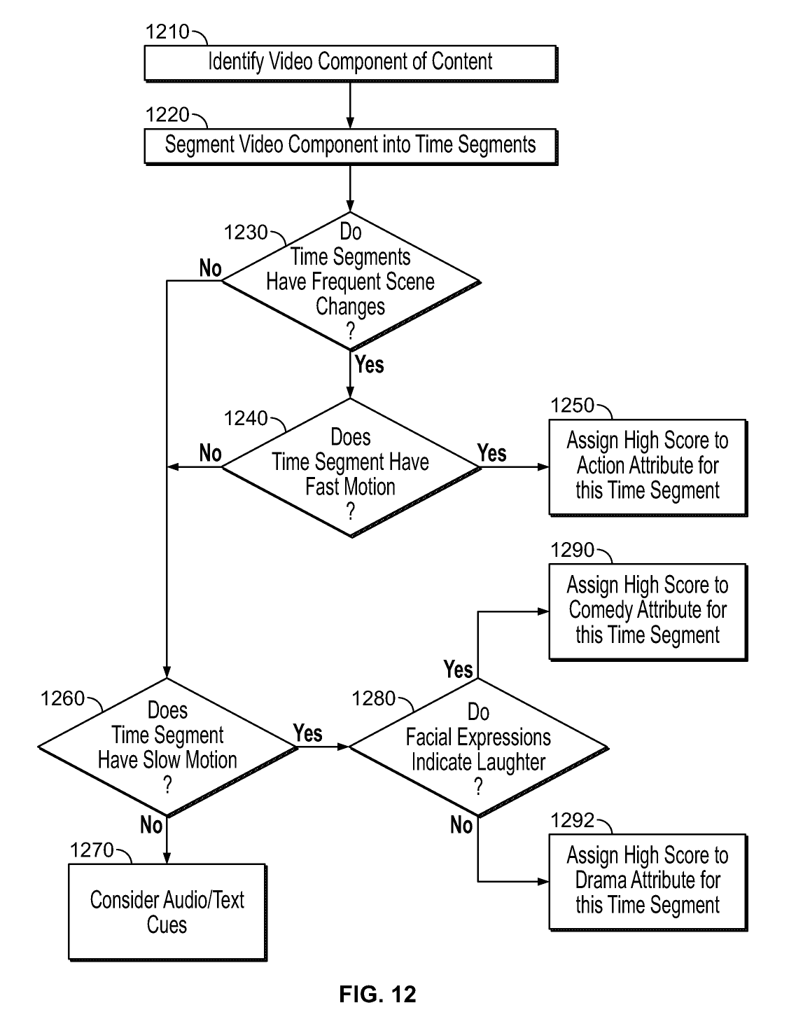

FIG. 12 shows an illustrative flow diagram for determining a genre categorization of a video component of a multimedia content, in accordance with an embodiment of the invention. At step 1210, the video component of the multimedia content may be identified. For example, if the multimedia content is a movie, the video component may be extracted. Identification of the video component may proceed in the manner described above in connection with FIGS. 8 and 9. For example, multimedia component identifier engine 920 of FIG. 9 may identify the video component.

At step 1220, the identified video component may be divided into multiple consecutive time segments. For example, the time segments may all be of duration 15:00 minutes each. Division of the video component into time segments may be performed by video processing engine 940 of FIG. 9 in the manner described above in connection with FIGS. 8 and 9. The time segments may further be preprocessed.

At step 1230, a determination may be made as to whether the time segments have frequent scene changes and/or frame cuts. This determination may be made for a time segment independently from other time segments. This determination may be made in the manner described above in connection with FIGS. 8 and 9. In response to a determination that a time segment has frequent scene changes and/or frame cuts, the process may proceed to step 1240. Otherwise the process may proceed to step 1260.

At step 1240, a determination may be made as to whether a time segment has a high degree of motion. This determination may be made in the manner described above in connection with FIGS. 8 and 9. In response to a determination that the time segment has a high degree of motion, the process may proceed to step 1250, where a high score may be assigned to the action genre for this time segment. A high confidence factor may also be associated to the score for the action genre. Otherwise, the process may proceed to step 1260.

At step 1260, a determination may be made as to whether a time segment has a low degree of motion. This determination may be made in the manner described above in connection with FIGS. 8 and 9. In response to a determination that the time segment does not have a low degree of motion, the process may proceed to step 1270, where control circuitry 304 may consider multimedia characteristics from audio or text components of the multimedia content. If the multimedia content does not have audio or text components, then a high score may be assigned to a genre such as drama. In response to a determination that the time segment has a low degree of motion, the process may proceed to step 1280.

At step 1280, a determination may be made as to whether the facial expressions in a time segment indicate laughter. This determination may be made in the manner described above in connection with FIGS. 8 and 9. In response to a determination that the facial expressions indicate laughter, the process may proceed to step 1290, where a high score may be assigned to the comedy genre for this time segment. A high confidence factor may also be associated to the score for the comedy genre. Otherwise, the process may proceed to step 1292, where a high score may be assigned to the drama genre for this time segment. A high confidence factor may also be associated to the score for the drama genre.

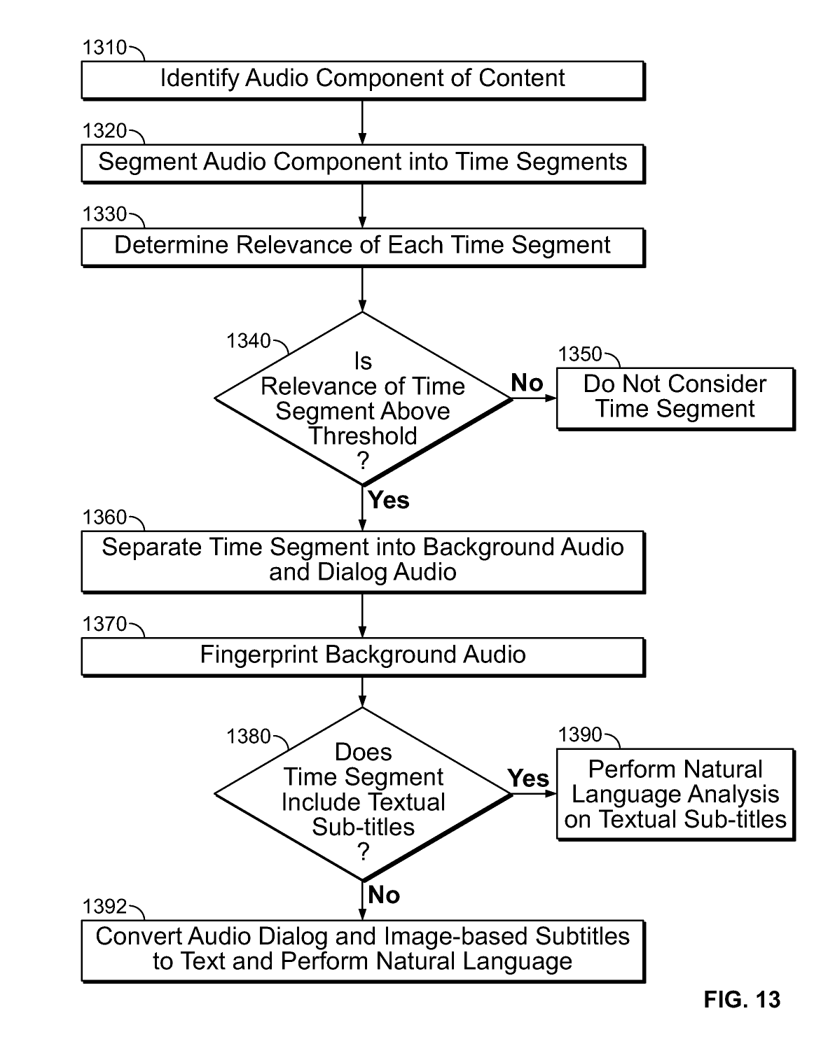

FIG. 13 shows an illustrative flow diagram for determining a genre categorization of an audio component of a multimedia content, in accordance with an embodiment of the invention. At step 1310, the audio component of the multimedia content may be identified. For example, if the multimedia content is a music file, the audio component may be extracted. Identification of the audio component may proceed in the manner described above in connection with FIGS. 8 and 9. For example, multimedia component identifier engine 920 of FIG. 9 may identify the audio component.

At step 1320, the identified audio component may be divided into multiple consecutive time segments.

For example, the time segments may all be of duration 15:00 minutes each. Division of the audio component into time segments may be performed by audio processing engine 930 of FIG. 9 in the manner described above in connection with FIGS. 8 and 9.

At step 1330, the time segments may be preprocessed. For example, audio processing engine 930 may preprocess audio input 820. Preprocessing may be performed by audio processing engine 930 of FIG. 9 in the manner described above in connection with FIGS. 8 and 9. For example, a relevance of time segments may be determined. For example, time segments that do not contain any audio may be determined to be the least relevant.

At step 1340, a determination may be made as to whether the relevance of each time segment is above a threshold. Time segments whose relevance is below the threshold may be discarded. Such a determination may be made by audio processing engine 930 of FIG. 9. In response to a determination that the relevance of a time segment is below the threshold, the process may proceed to step 1350 where the time segment may be discarded. A zero score per genre may be assigned to each discarded time segment. Otherwise the process may proceed to step 1360.

At step 1360, preprocessed timed segments may be separated into background audio and dialog audio components. Such separation may be made in the manner described above in connection with FIGS. 8 and 9. For example, audio processing engine 930 may demultiplex time segments of audio input 820 that were not discarded.

At step 1370, the background audio component may be fingerprinted. Fingerprinting may occur in the manner described above in connection with FIGS. 8 and 9. For example, the background audio component may be analyzed to determine whether it contains music signatures corresponding to known genres. Genres like action or drama may be associated with music clips whose presence in the background audio component may act as a signature of the corresponding genre. Music signatures may be stored in storage 308. Music signatures may be determined offline. Music signatures may also be determined and improved during the generation of temporal genre charts.

At step 1380, a determination may be made as to whether the time segment contains textual subtitles. Textual subtitles may be subtitles in text format. In response to a determination that the time segment includes textual subtitles, the process may proceed to step 1390 where natural language analysis may be performed on the textual subtitles. Natural language analysis may be performed by text processing engine 950 of FIG. 9 as described above in connection with FIGS. 8 and 9. Otherwise the process may proceed to step 1392.

At step 1392, the dialog audio component and image-based subtitles may be converted to text and natural language analysis may be performed. Image-based subtitles may be subtitles in image format. Text conversion and natural language analysis may be performed by audio processing engine 930 and/or text processing engine 950 of FIG. 9 as described above in connection with FIGS. 8 and 9. The dialog audio component may also be analyzed for dialog signatures in the same way that the background audio component was analyzed for music signatures. Natural language analysis may result in the determination of scores per genre in each time segment of audio input 820 that was not discarded. The process may then terminate.

It should be understood that the above steps of the flow diagrams of FIGS. 11-13 may be executed or performed in any order or sequence not limited to the order and sequence shown and described in the figures. Also, some of the above steps of the flow diagrams of FIGS. 11-13 may be executed or performed substantially simultaneously where appropriate or in parallel to reduce latency and processing times.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The above-described embodiments of the present disclosure are presented for purposes of illustration and not of limitation, and the present disclosure is limited only by the claims which follow.

1. A method for determining a plurality of attributes of multimedia content over time, the method comprising:
identifying, using a processor, multimedia characteristics of the multimedia content in each of a plurality of time segments of the multimedia content;
identifying, based on the identified characteristics, a level of each of the plurality of attributes in each of the plurality of time segments;
storing, in memory, the determined levels of each of the plurality of attributes; and
generating a time-based visual representation of the determined levels of the plurality of attributes, wherein the time-based visual representation visually indicates the determined level of each of the plurality of attributes with respect to each of the plurality of time segments.

2. The method of claim 1, wherein identifying the multimedia characteristics comprises:
cross-referencing a video or audio component of the multimedia content, for each of the plurality of time segments of the multimedia content, with a database of multimedia characteristics to determine a multimedia characteristic associated with the video or audio component.

3. The method of claim 1, wherein the determining the level of each of the plurality of attributes comprises:
determining at least one of a degree of motion in a video component of the multimedia content, a number of scene changes in the video component, and facial expressions of actors in the video component.

4. The method of claim 1, wherein the determining the level of each of the plurality of attributes comprises:
separating an audio component of the multimedia content into a background track and a dialog track; and
fingerprinting the background track and the dialog track to determine the level of each of the attributes.

5. The method of claim 1, wherein the determining the level of each of the plurality of attributes comprises:
performing natural language analysis of a text component of the multimedia content.

6. The method of claim 1 further comprising:
preprocessing the multimedia content by determining a relevance value of each of the time segments of the plurality of time segments; and
determining the level of each of the plurality of attributes in each of the time segments whose relevance value is above a threshold.

7. The method of claim 1 further comprising:
assigning a confidence factor to the determined level of each of the plurality of attributes for each of the plurality of time segments.

8. The method of claim 7 further comprising:
determining a conflict in the determined level of one of the plurality of attributes;
requesting user input to resolve the conflict; and
correcting, based on the received user input, the level of the one of the plurality of attributes for which the conflict was determined.

9. The method of claim 7 further comprising:
determining a conflict in the determined level of one of the plurality of attributes;
inputting the plurality of attributes into a predetermined formula for resolving the conflict; and
correcting, based on the result of applying the formula, the level of the one of the plurality of attributes for which the conflict was determined.

10. The method of claim 1, wherein the time-based visual representation is overlaid on top of a display of the multimedia content.

11. The method of claim 1, wherein the time-based visual representation is a 3D visual representation indicating on separate axes: the plurality of attributes, the determined levels of the plurality of attributes, and the time segments.

12. A system for determining a plurality of attributes of multimedia content over time, the system comprising control circuitry configured to:
identify multimedia characteristics of the multimedia content at each of a plurality of time segments of the multimedia content;
identify, based on the identified characteristics, a level of each of the plurality of attributes in each of the plurality of time segments;
store, in memory, the determined levels of each of the plurality of attributes; and
generate a time-based visual representation of the determined levels of the plurality of attributes, wherein the time-based visual representation visually indicates the determined level of each of the plurality of attributes with respect to each of the plurality of time segments.

13. The system of claim 12, wherein the control circuitry is further configured to identify the multimedia characteristics by:
cross-referencing a video or audio component of the multimedia content, for each of the plurality of time segments of the multimedia content, with a database of multimedia characteristics to determine a multimedia characteristic associated with the video or audio component.

14. The system of claim 12, wherein the control circuitry is further configured to determine the level of each of the plurality of attributes by:
determining at least one of a degree of motion in a video component of the multimedia content, a number of scene changes in the video component, and facial expressions of actors in the video component.

15. The system of claim 12, wherein the control circuitry is further configured to determine the level of each of the plurality of attributes by:
separating an audio component of the multimedia content into a background track and a dialog track; and
fingerprinting the background track and the dialog track to determine the level of each of the attributes.

16. The system of claim 12, wherein the control circuitry is further configured to determine the level of each of the plurality of attributes by:
performing natural language analysis of a text component of the multimedia content.

17. The system of claim 12, wherein the control circuitry is further configured to:
preprocess the multimedia content by determining a relevance value of each of the time segments of the plurality of time segments; and
determine the level of each of the plurality of attributes in each of the time segments whose relevance value is above a threshold.

18. The system of claim 12, wherein the control circuitry is further configured to:
assign a confidence factor to the determined level of each of the plurality of attributes for each of the plurality of time segments.

19. The system of claim 18, wherein the control circuitry is further configured to:
determine a conflict in the determined level of one of the plurality of attributes;
request user input to resolve the conflict; and
correct, based on the received user input, the level of the one of the plurality of attributes for which the conflict was determined.

20. The system of claim 18, wherein the control circuitry is further configured to:
determine a conflict in the determined level of one of the plurality of attributes;
input the plurality of attributes into a predetermined formula for resolving the conflict; and
correct, based on the result of applying the formula, the level of the one of the plurality of attributes for which the conflict was determined.

21. The system of claim 12, wherein the time-based visual representation is overlaid on top of a display of the multimedia content.

22. The system of claim 12, wherein the time-based visual representation is a 3D visual representation indicating on separate axes: the plurality of attributes, the determined levels of the plurality of attributes, and the time segments.

23-33. (canceled)
